(19) United States
(12) Patent Application Publication
(10) Pub. No.: US 2018/0059575 A1
(43) Pub. Date: Mar. 1, 2018

(54) IMAGE FORMING APPARATUS

(71) Applicant: CANON KABUSHIKI KAISHA, Tokyo (JP)

(72) Inventor: Takeyuki Suda, Nagareyama-shi (JP)

(21) Appl. No.: 15/678,374

(22) Filed: Aug. 16, 2017

(30) Foreign Application Priority Data
Aug. 24, 2016 (JP) 2016-163446

(51) Int. Cl. G03G 15/08

(52) U.S. Cl. CPC G03G 15/0881

(57) ABSTRACT

Provided is an image forming apparatus including: first and second chambers communicating to each other; a first opening portion through which the developer is received from the first chamber to the second chamber; a second opening portion through which the developer is received from the second chamber to the first chamber; a conveyance member arranged in the first chamber and rotating in a first direction to convey the developer to the first opening portion; a sealing member sealing the first opening portion; a rotary member peeling the sealing member; a determination portion determining presence of uneven distribution in the first chamber under a state in which the sealing member seals; and a controller controlling rotation of the rotary member to rotate the conveyance member in a second direction reverse to the first direction before the peeling or in a course of the peeling when the uneven distribution is present.

### BACKGROUND OF THE INVENTION

### Field of the Invention

The present invention relates to an image forming apparatus.

### Description of the Related Art

In an image forming apparatus of an electrophotographic type, an electrostatic latent image is formed on a photosensitive member being an image bearing member through charging and exposing. In the image forming apparatus, the electrostatic latent image is developed with use of toner being developer to form a toner image, and the toner image is transferred onto a recording medium, thereby forming an image on the recording medium.

There has been known an image forming apparatus which employs a cartridge type to deal with replacement of components having different lifetimes and replenishment of consumable products such as toner. For example, there has been known a developing cartridge integrally including a toner container, which is configured to receive toner, and a developing roller. Further, there has been known a process cartridge integrally including a photosensitive member, a charging portion, and a cleaning portion in addition to the toner container and the developing roller. In this cartridge, in general, an opening portion of the toner container configured to receive toner is sealed with a seal member to prevent leakage of toner during transport or replacement of the cartridge.

This cartridge requires peeling of the seal member from the opening portion when the cartridge is mounted to an image forming apparatus main body. There have been known a cartridge from which the seal member is manually peeled before mounting the cartridge, and a cartridge from which the seal member is automatically peeled after mounting the cartridge to the main body.

In Japanese Patent Application Laid-Open No. 2005-43535, the following configuration is disclosed. A rotary member is provided in a cartridge, and a seal member is automatically reeled up by the rotary member, thereby peeling the seal member from an opening portion. The rotary member generates load torque only at the time of peeling the seal member, and there is substantially no load after unsealing. Therefore, no dedicated drive motor is provided, and a common motor is used for rotation of a toner conveying (mixing) screw in the cartridge and for the rotary member.

According to the related art, in some cases, initial developer contained in the cartridge is unevenly distributed on the opening portion side depending on a state of transport or storage before mounting the cartridge to the main body. In general, the rotary member configured to peel the seal member and the toner conveying screw in the cartridge are driven by a common motor. Therefore, there has been a case where the toner conveying screw compresses the initial developer to increase load torque, with the result that the load torque is applied for the seal-peeling.

### SUMMARY OF THE INVENTION

The present invention has an object to provide an image forming apparatus, which is capable of peeling a sealing member with small load torque.

The present invention has another object to provide an image forming apparatus including: a first chamber configured to store the developer and to convey the developer; a second chamber communicating to the first chamber to circulate the developer; a first opening portion through which the developer is received from the first chamber to the second chamber; a second opening portion through which the developer is received from the second chamber to the first chamber; a conveyance member arranged in the first chamber and configured to rotate in a first direction to convey the developer to the first opening portion; a sealing member configured to seal the first opening portion and the second opening portion so as to store the developer in the first chamber; a rotatable rotary member configured to peel the sealing member from the first opening portion through reception of a drive force; a determination portion configured to determine presence of uneven distribution in the first chamber under a state in which the sealing member seals the first opening portion; and a controller configured to control rotation of the rotary member based on output of the determination portion so as to rotate the conveyance member in a second direction reverse to the first direction before peeling the sealing member from the first opening portion or in a course of an operation of peeling the sealing member from the first opening portion when the uneven distribution, in which a large amount of developer is present on a side of the first opening portion, is present in the first chamber.

Further features of the present invention will become apparent from the following description of exemplary embodiments with reference to the attached drawings.

### BRIEF DESCRIPTION OF THE DRAWINGS

FIG. 1 is an explanatory view for illustrating an image forming apparatus according to one embodiment of the present invention.

FIG. 2 is a block diagram of a first embodiment of the present invention.

FIG. 3 is a flowchart for a main controller of the first embodiment.

FIG. 4 is a drive configuration diagram of a developing device of the first embodiment.

FIG. 5 is a sectional view of the developing device of the first embodiment.

FIG. 6 is an illustration of a relationship between distribution of developer and a position of a sensor in the developing device of the first embodiment.

FIG. 7 is an illustration of an example of output waveforms of the sensor of the first embodiment.

FIG. 8 is a flowchart for a main controller of a second embodiment of the present invention.

FIG. 9 is a graph for showing a relationship between a motor current and a threshold value of the second embodiment.

### DESCRIPTION OF THE EMBODIMENTS

In the following, description is made of embodiments of the present invention with reference to the drawings.

### First Embodiment

(Image Forming Apparatus)

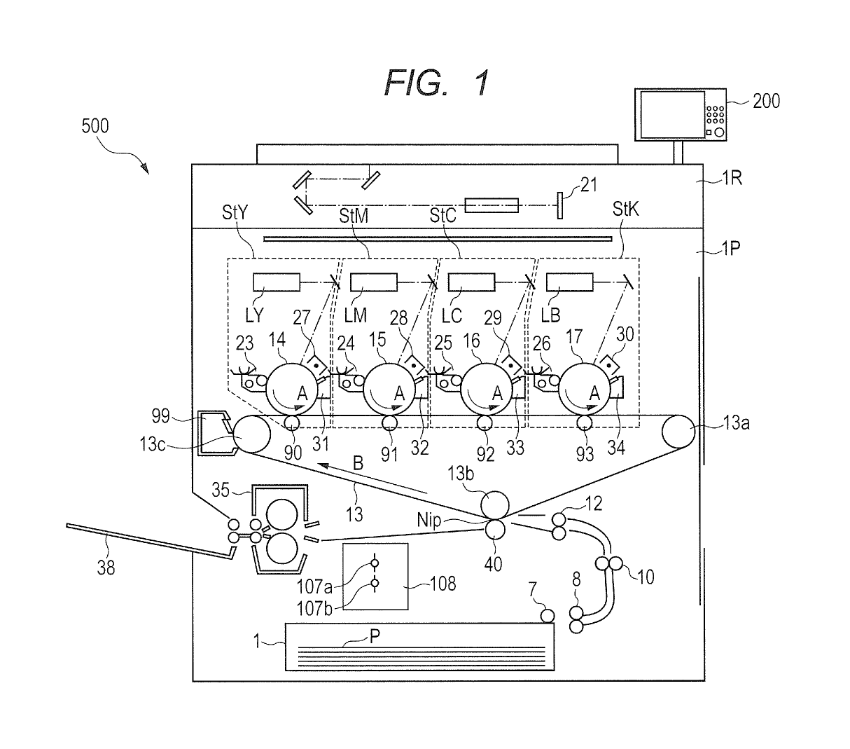

FIG. 1 is a schematic sectional view of an image forming apparatus 500 according to a first embodiment of the present invention. The image forming apparatus 500 includes an operation panel 200, a reader unit 1R, and a printer unit 1P. The printer unit 1P includes four image forming portions StY, StM, StC, and StK, which are configured to form developer images (toner images) of respective color components. The image forming portion StY is configured to form a yellow toner image. The image forming portion StM is configured to form a magenta toner image. The image forming portion StC is configured to form a cyan toner image. The image forming portion StK is configured to form a black toner image.

The image forming portion StY includes a photosensitive drum 14, a charging device 27, and an exposure device LY. The photosensitive drum 14 is configured to bear a toner image of a yellow color component. The charging device 27 is configured to charge the photosensitive drum 14. The exposure device LY is configured to expose the photosensitive drum 14 with light to form an electrostatic latent image corresponding to the yellow color component on the photosensitive drum 14.

Further, the image forming portion StY includes a developing device 23. The developing device 23 is a developing apparatus, which is configured to visualize the electrostatic latent image formed on the photosensitive drum 14 as a toner image with use of developer containing toner and includes a developer storage portion. The image forming portion StY includes a primary transfer roller 90 configured to transfer the toner image on the photosensitive drum 14 onto an intermediate transfer belt 13. A detailed configuration of the developing device 23 including the developer storage portion, which is configured to store the developer and has openings in a conveyance path for conveyance of the developer, is described later.

Further, the image forming portion StY includes a drum cleaner 31. The drum cleaner 31 is configured to remove toner, which is not transferred onto the intermediate transfer belt 13 and remains on the photosensitive drum 14. The drum cleaner 31 includes a cleaner blade formed of a plate-like rubber member. When the photosensitive drum 14 is rotated in the direction indicated by the arrow A under a state in which the cleaner blade is held in abutment against the photosensitive drum 14 with a predetermined force, the toner which remains on the photosensitive drum 14 can be swept up. That is, the drum cleaner 31 serves as a cleaning portion configured to clean the toner which remains on the photosensitive drum 14 being the image bearing member.

Each of the image forming portions StM, StC, and StK is the same as the image forming portion StY configured to form the yellow toner image. That is, the image forming portion StM includes a photosensitive drum 15, a charging device 28, an exposure device LM, a developing device 24, a primary transfer roller 91, and a drum cleaner 32. The image forming portion StC includes a photosensitive drum 16, a charging device 29, an exposure device LC, a developing device 25, a primary transfer roller 92, and a drum cleaner 33. The image forming portion StK includes a photosensitive drum 17, a charging device 30, an exposure device LB, a developing device 26, a primary transfer roller 93, and a drum cleaner 34.

The intermediate transfer belt 13 is an intermediate transfer member configured to bear the toner images. The intermediate transfer belt 13 receives the toner images of respective color components, which are formed by the image forming portions StY, StM, StC, and StK, in a superposed manner, to thereby bear a full-color toner image. A secondary transfer opposed roller 13b and a secondary transfer roller 40, which are configured to transfer the toner image on the intermediate transfer belt 13 onto a recording material P, for example, a paper sheet, are arranged around the intermediate transfer belt 13. Further, the intermediate transfer belt 13 is stretched around a driving roller 13a, the secondary transfer opposed roller 13b, and a driven roller 13c. Rotation of the driving roller 13a causes the intermediate transfer belt 13 to move in the direction indicated by the arrow B.

Further, on the intermediate transfer belt 13, there is provided a belt cleaner 99 configured to remove toner, which is not transferred onto the recording material P from the intermediate transfer belt 13 and remains thereon. Similarly to the drum cleaner 31, the belt cleaner 99 also includes a cleaner blade formed of a plate-like rubber member. When the intermediate transfer belt 13 is rotated in the direction indicated by the arrow B under a state in which the cleaner blade is held in abutment against the intermediate transfer belt 13 with a predetermined force, the toner which remains on the intermediate transfer belt 13 can be swept up. That is, the belt cleaner 99 configured to clean the toner remaining on the intermediate transfer belt 13 also serves as a cleaning portion.

The fixing device 35 includes a heat roller and a pressure roller, and is configured to fix the toner image, which is born on the recording material P, by heat and pressure.

The operation panel 200 includes numerical keys, a copy button, mode selection buttons, and a liquid crystal screen. The numerical keys allow input of, for example, the number of sheets subjected to image formation. The copy button allows starting of image formation. The mode selection buttons allow setting of various printing modes such as simplex printing and duplex printing. The liquid crystal screen is capable of displaying guidance for supporting various operations to the image forming apparatus. The liquid crystal screen includes a touch panel.

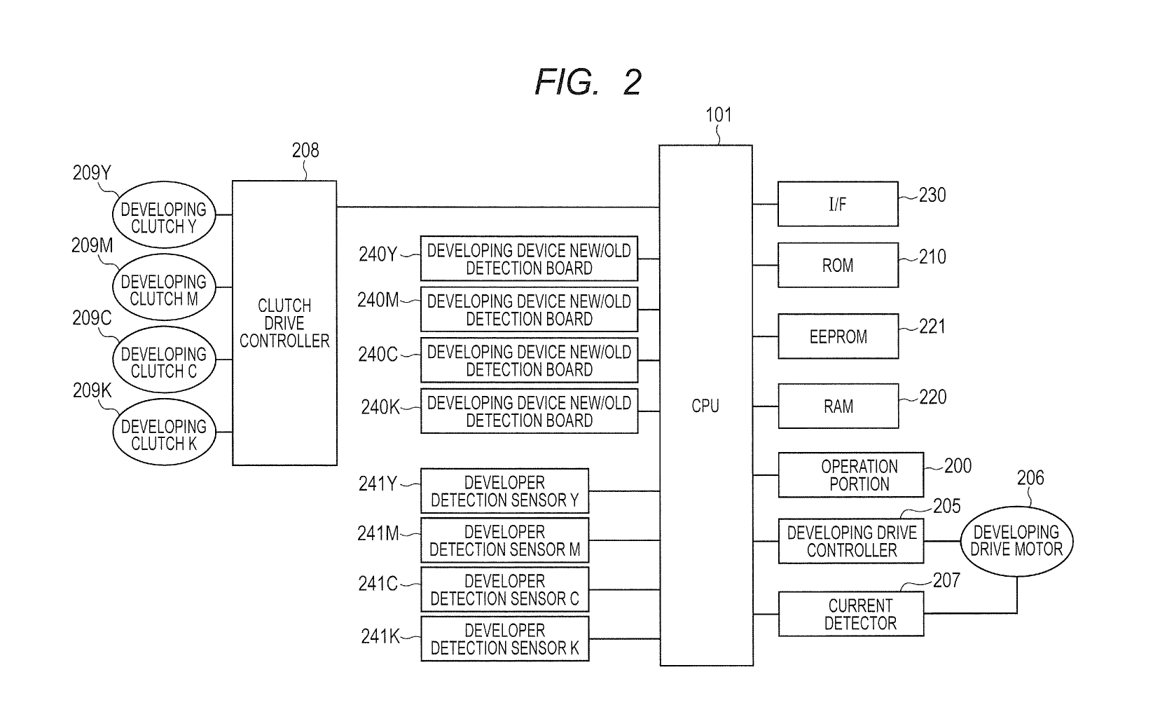

At the reader unit 1R, an original is placed on an original table. When the copy button of the operation panel 200 is pressed by a user, light is irradiated to the original, and light reflected from the original is received at an image sensor 21 via a reflection mirror. The image sensor 21 receives the reflected light from the original as luminance signals of red, blue, and green through a color filter. The luminance signals obtained by the image sensor 21 are subjected to well-known image processing by a CPU 101 (FIG. 2) and converted into image data for formation of toner images of the respective color components of yellow, magenta, cyan, and black.

The reader unit 1R reads the original to obtain the image data in the image forming apparatus 500. The image forming apparatus 500 also has a configuration in which image data is transferred through an I/F 230 from external devices such as a scanner and a PC which are communicably connected to the image forming apparatus 500.

(Image Forming Operation)

Description is made of an image forming operation of forming an image in accordance with image data by the printer unit 1P. In the image forming portion StY, a surface of the photosensitive drum 14 is uniformly charged by the charging device 27. The exposure device LY exposes the photosensitive drum 14 to a laser beam which is modulated in accordance with image data corresponding to yellow. With this action, an electrostatic latent image corresponding to the yellow color component of the image data is formed on the surface of the photosensitive drum 14.

Next, when the electrostatic latent image on the photosensitive drum 14 is visualized by the toner of the developing device 23, the toner image corresponding to the yellow color component is born on the photosensitive drum 14. The toner image of the yellow color component is conveyed to a primary transfer portion along with rotation of the photosensitive drum 14 in the direction indicated by the arrow A. At the primary transfer portion, the primary transfer roller 90 presses the photosensitive drum 14 through intermediation of the intermediate transfer belt 13.

Under a state in which a transfer voltage is applied to the primary transfer roller 90, the toner image of the yellow color component on the photosensitive drum 14 passes through the primary transfer portion. Then, the toner image of the yellow color component is transferred onto the intermediate transfer belt 13. The image forming portions StM, StC, and StK form images of respective color components on the photosensitive drums 15, 16, and 17 by the processing which is the same as the processing of forming the image of the yellow color component by the image forming portion StY.

The image forming portions StY, StM, StC, and StK successively transfer the toner images corresponding to the respective color components of the image data onto the intermediate transfer belt 13 in a superposed manner. With this action, the full-color toner image is formed on the intermediate transfer belt 13.

The full-color toner image born on the intermediate transfer belt 13 is conveyed to a secondary transfer portion Nip along with movement of the intermediate transfer belt 13 in the direction indicated by the arrow B. At the secondary transfer portion Nip, the secondary transfer roller 40 presses the secondary transfer opposed roller 13b through intermediation of the intermediate transfer belt 13.

The recording material P in a sheet-feeding cassette 1 is fed one after another by a pickup roller 7, a sheet-feeding roller pair 8, and a conveyance roller pair 10, and is conveyed to the secondary transfer portion Nip. Registration rollers 12 adjust a position to a delivery timing of the recording material P conveyed by the sheet-feeding roller pair 8 and the conveyance roller pair 10. The recording material P is fed to the secondary transfer portion Nip so as to be brought into contact with the toner image on the intermediate transfer belt 13.

The toner image on the intermediate transfer belt and the recording material P delivered from the registration rollers 12 enter the secondary transfer portion Nip. Then, the transfer voltage is applied to the secondary transfer roller 40, and a transfer electric field is formed between the secondary transfer opposed roller 13b and the secondary transfer roller 40. With this action, the toner image on the intermediate transfer belt 13 is transferred onto the recording material P.

The recording material P onto which the toner image is transferred at the secondary transfer portion Nip is conveyed to the fixing device 35. At the fixing device 35, the heat roller and the pressure roller heat the recording material P with a heater provided in the heat roller while nipping and conveying the recording material P, to thereby fix the toner image onto the recording material P. After that, the recording material P onto which the toner image is fixed is delivered to a sheet delivery tray 38.

(Block Diagram)

FIG. 2 is a block diagram of the first embodiment. The main controller (CPU) 101 includes an EEPROM 221, a RAM 220, and a ROM 210. The main controller 101 executes a program stored in the ROM 210 to perform functions of image processing, image formation, and sheet conveyance control, thereby controlling the entire image forming apparatus.

Driving of the developing devices 23, 24, 25, and 26 (developing drive motor 206 and developing clutches 209Y, 209M, 209C, and 209K) is performed through control of a developing drive controller 205 and a clutch drive controller 208 by the main controller 101. Developer detection sensors 241 can be read by the main controller 101, and a ratio of toner to carrier (hereinafter referred to as “T/D ratio”) in each developing device can be detected in accordance with a result of reading.

The developer detection sensor 241 of the first embodiment is configured to detect the T/D ratio. The amount of the initial developer filled in a new developing device 23 is set to a certain amount at the time of manufacture. Therefore, the developer detection sensor 241 is also capable of detecting a state in which the developer is not present on a detection surface of the developer detection sensor 241 or a state in which a large amount of developer is present on the detection surface of the developer detection sensor 241, which are caused by uneven distribution of the initial developer. A developing device new/old detection board 240 is configured to determine whether or not the developing device is new.

(Flowchart)

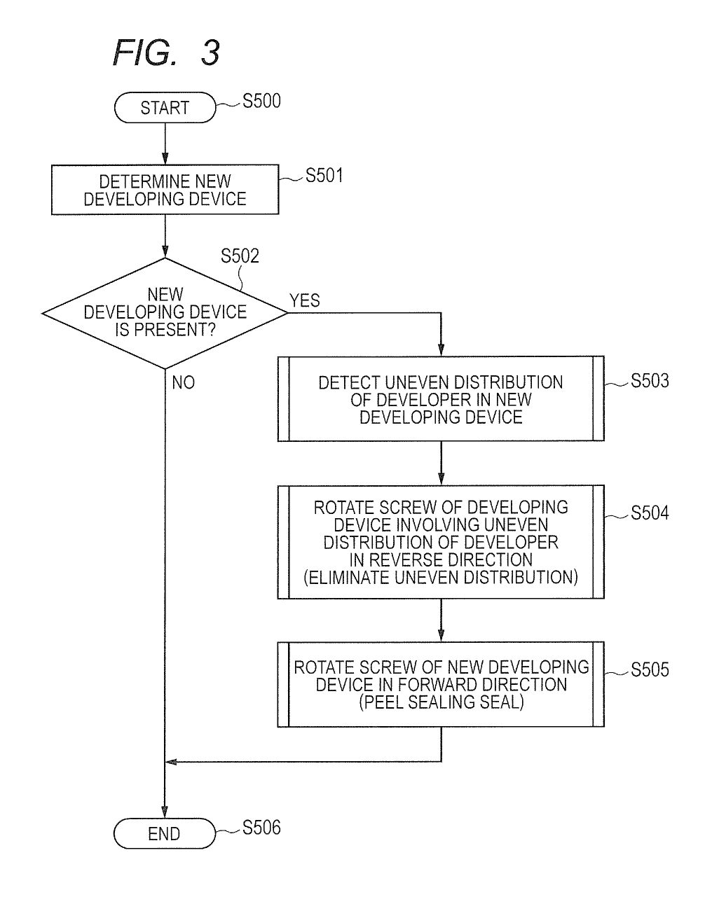

With reference to the flowchart of FIG. 3, description is made of detection for uneven distribution of the initial developer and operation of peeling a seal member 405 in the first embodiment. The processing illustrated in the flowchart is executed by the main controller 101.

After the new developing device 23 is mounted to the image forming apparatus main body, initialization processing for the new developing device 23 is performed through the operation portion 200 (Step S500). Determination of which of the developing devices for respective colors of yellow, magenta, cyan, and black is new is performed through communication to/from the developing device new/old detection boards 240 mounted to the developing devices 23, 24, 25, and 26 (Step S501). Then, the initialization processing is performed for the new developing device (Step S502).

Even when the developing device new/old detection boards 240 are not used, the initialization processing can similarly be performed, for example, by using the operation portion to designate a station to which the new developing device is set at the time of starting the initialization processing. When it is determined in the determination of Step S502 that the new developing device is absent, the processing is ended because there is no need to perform an unsealing operation (Step S506).

(Developing Apparatus)

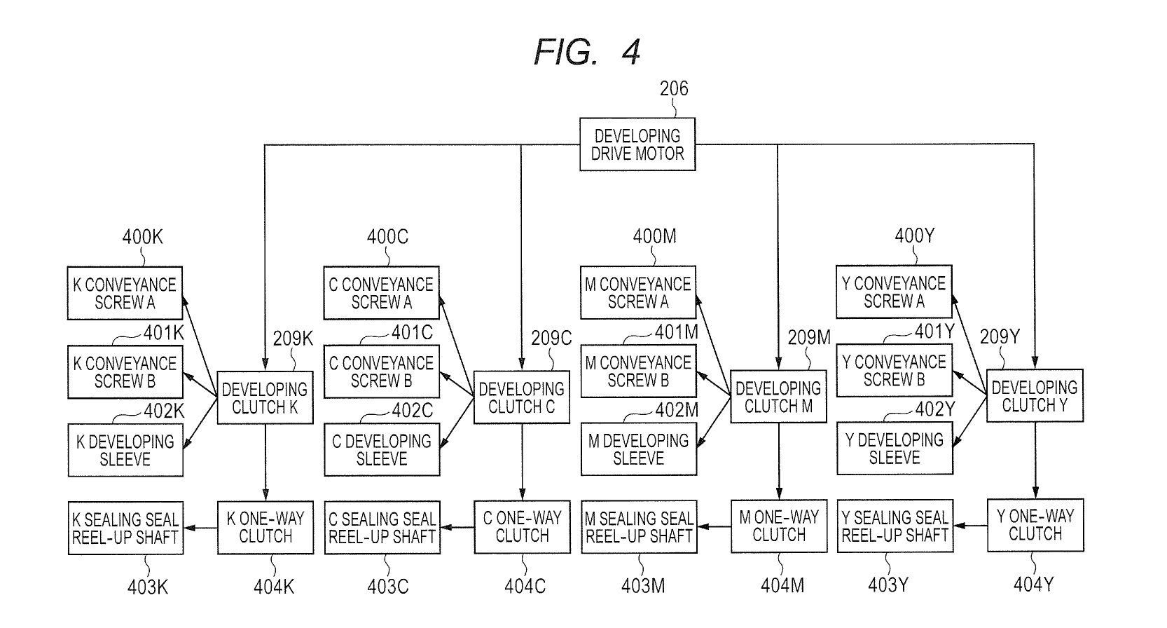

With reference to a drive configuration diagram of FIG. 4 and a sectional view of FIG. 5, description is made of the developing devices 23, 24, 25, and 26 being developing apparatus including developer storage portions for respective colors. The developing devices for four colors are illustrated in FIG. 4, but only the developing device for yellow is described because configurations of the developing devices for respective colors are the same.

As illustrated in FIG. 5, the developing apparatus includes a developing sleeve 402 being a developer carrying member configured to form a toner image on the photosensitive drum. The developer circulates in a first chamber 406 and a second chamber 407 through opening portions 408, 409. For circulation of the developer, a first screw 400 being a conveyance member configured to convey the developer is provided in the first chamber 406, and a second screw 401 being a conveyance member configured to convey the developer is provided in the second chamber 407. As the opening portions, the first opening portion 408 and the second opening portion 409 are provided. The first opening portion 408 allows the developer to be delivered from the first chamber to the second chamber. The second opening portion 409 allows the developer to be delivered from the second chamber to the first chamber. The first screw 400 conveys the developer in a first conveyance direction from the second opening portion 409 to the first opening portion 408. The second screw 401 conveys the developer in a second conveyance direction, which is reverse to the first conveyance direction, from the first opening portion 408 to the second opening portion 409.

As illustrated in FIG. 4, during rotation of the developing drive motor 206, the drive is transmitted to the developing devices 23, 24, 25, and 26 for respective colors through the developing clutches 209 for respective colors. In the developing device 23 for yellow, there are provided a Y conveyance screw A 400Y, a Y conveyance screw B 401Y, a Y developing sleeve 402Y, and a Y sealing seal reel-up shaft 403Y (rotary member). The Y sealing seal reel-up shaft 403Y has a connection surface to which the seal member 405 is connected, and is configured to peel the seal member through rotation. The Y sealing seal reel-up shaft 403Y is rotated through connection to the developing clutch Y 209Y.

The developing drive motor 206 rotates in a reverse direction (second direction) with respect to a forward direction (first direction). When the developing drive motor 206 rotates in the reverse direction, the drive is cut by an action of a Y one-way clutch 404Y being a one-way transmission portion, and a drive force is not transmitted. As a result, the Y sealing seal reel-up shaft 403Y does not operate or rotate.

In the first embodiment, the drive is transmitted to the developing devices 23, 24, 25, and 26 for respective colors through the developing clutches 209. However, motors may be independently connected to the developing devices 23, 24, 25, and 26.

(Unsealing Operation)

Description is made of an unsealing operation for the developing device 23 which is determined as being new in Step S501 of FIG. 3. When the initial developer in the new developing device is unevenly distributed to a periphery of the opening portion in the developing device, there is a case where the load torque is increased during an operation of peeling the seal member 405 being the sealing member.

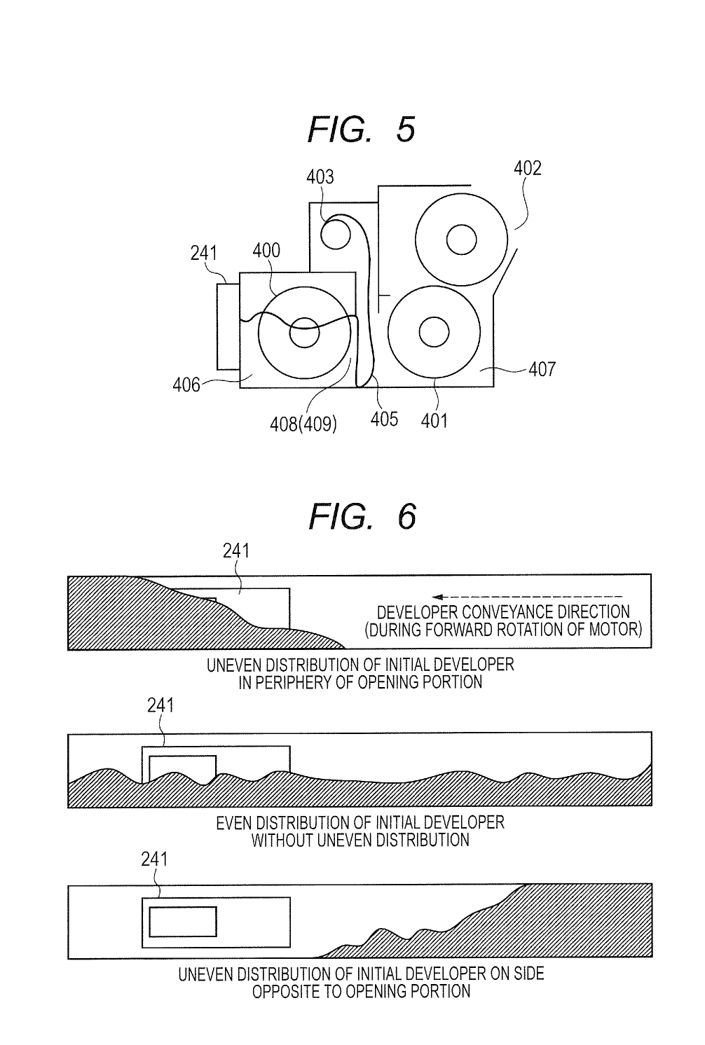

Therefore, before the peeling operation is performed, a state of uneven distribution of the initial developer is determined in accordance with an output waveform of an inductance sensor 241 (Step S503). The inductance sensor 241 is arranged in a periphery of the opening portion in the developing device 23 as illustrated in FIG. 6, and is used for detection of the T/D ratio of the developer at the time of performing a printing operation.

The inductance sensor 241 is configured to detect a change in inductance. Therefore, when uneven distribution of the developer provided inside occurs due to the posture during the storage, such as before the peeling of the seal, the amount of developer in a periphery of the detection surface of the inductance sensor 241 significantly changes. Thus, the uneven distribution of the initial developer can be detected in accordance with the output of the inductance sensor 241.

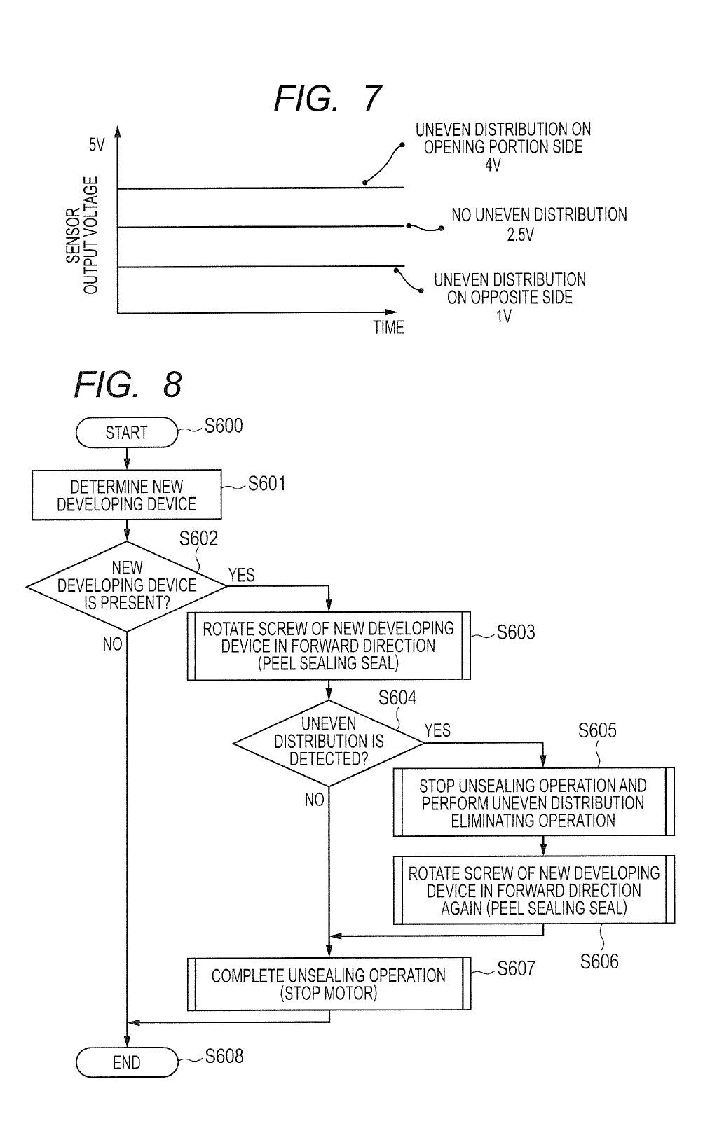

FIG. 7 is an illustration of an example of the output waveforms of the inductance sensor 241. When an output value of the inductance sensor is high, that is, when an output value as compared to a predetermined value, for example, 4 V, is equal to or more than 4 V as a comparison result, the main controller 101 (determination portion) determines that the developer is unevenly distributed to a periphery of the opening (opening portion). When the output value is low (for example, equal to or less than 2.5 V), the main controller 101 determines that the uneven distribution does not occur in the developing device, or determines that the developer is unevenly distributed in a direction opposite to the opening portion.

In the first embodiment, for the developing device in which the developer is unevenly distributed to a periphery of the opening portion, the screw A 400 in the developing device is reversely rotated before performing the unsealing operation. That is, an uneven distribution eliminating operation of rotating the developing drive motor 206 in the direction reverse to that in the normal state, reversely rotating the screw A 400 through connection of the developing clutch 209 only for a predetermined time period (for example, 2 seconds), and thereafter stopping the developing drive motor 206 to stop the screw A 400 is performed (Step S504). During the operation of the reverse rotation, the reel-up shaft 403 configured to peel the seal member 405 is in a state in which the drive is not transmitted by the one-way clutch 404. Therefore, the reel-up shaft 403 is not rotated.

Next, in order to perform the unsealing operation for the new developing device, the developing drive motor 206 is caused to rotate in the forward direction (first direction) to connect the developing clutch 209. With this operation, the seal member 405 is reeled up by the reel-up shaft 403 in the developing device 23. At the same time, the developer is conveyed by the conveyance screws A 400 and B 401 in the developing device.

Then, after the seal member 405 is sufficiently reeled up, and the drive is continued until the initial developer circulates in the developing device 23, the connection of the developing clutch 209 is cut, and the developing motor 206 is stopped (Step S505), with the result that the series of processing is ended (Step S506). The operation described above is the unsealing operation for the new developing device. Various image adjustment (for example, density correction and gradation correction) may be performed subsequent to the above-mentioned operation.

### Second Embodiment

Description is made of a second embodiment of the present invention, in which the detection for uneven distribution of the developer in the developing device is performed in accordance with a drive current waveform of the developing motor 206 (driving portion). Description of portions which are the same as those of the first embodiment is omitted.

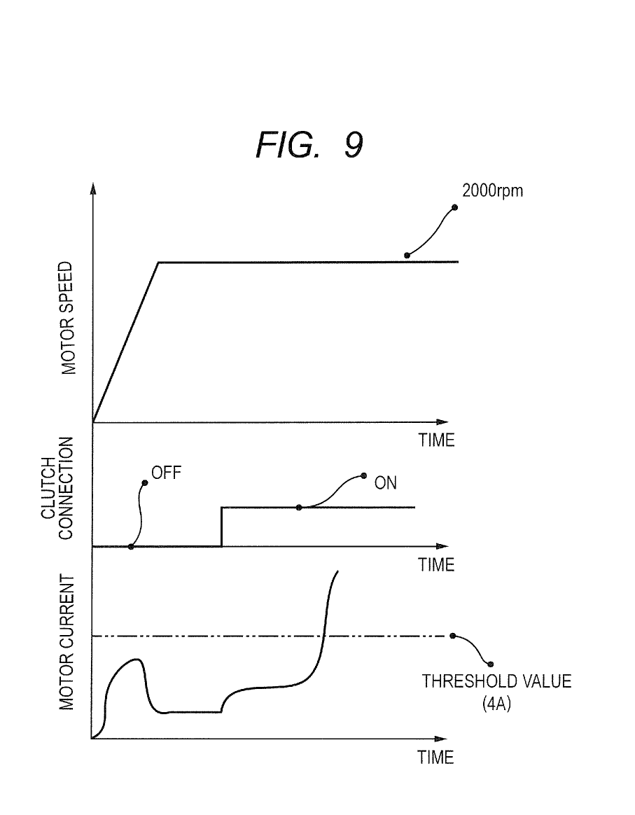

FIG. 8 is a flowchart of processing executed in the second embodiment. After a new developing device is set, the initialization processing for the developing device 23 is started in accordance with an instruction from the operation portion 200 (Step 600). When the developing device 23 determined as being new (Step S601) is present (Step S602), the unsealing operation is performed (Step S603). At this point of time, the uneven distribution of the initial developer in the developing device is not detected. Then, while the unsealing operation is performed, a drive current of the developing motor 206 is monitored by a current detector 207. When the drive current is equal to or more than a threshold value (4 A) as shown in FIG. 9, it is determined that the uneven distribution of the developer occurs (Step S604).

In this case, in order to stop the unsealing operation for the developing device, the connection of the developing clutch 209 is cut to stop the drive motor 206 (Step S605).

With reference to FIG. 9, description is made of the uneven distribution of the initial developer and the rise in driving motor current. When the developer is unevenly distributed, the developer is compressed by the conveyance screw A 400 being rotated simultaneously with the unsealing operation. The rise in load torque is captured in an initial stage when the current exceeds the threshold value. With this action, the developing clutch 209 is turned off in a stage before the load torque rises completely, thereby stopping the rise in torque.

The motor speed is controlled so as to be constant during the unsealing operation. Therefore, a rapid rise in motor current due to acceleration or deceleration torque does not occur. With this, the rise in the current can be limited to the rise due to the uneven distribution of the developer.

In FIG. 9, the drive current rises even beyond the threshold value. However, in the actual control, the connection of the developing clutch 209 is cut at the point of time of exceeding the threshold value (4 A). Therefore, the drive current becomes equal to or less than the threshold value (4 A) before reaching the maximum value in FIG. 9, and a large torque is not applied to a drive train. For the developing device which is not determined as involving the uneven distribution, the unsealing operation can be completed without interrupting.

Referring back to FIG. 8, for the developing device in which the unsealing operation is interrupted in accordance with the determination, the screw in the developing device is reversely rotated to eliminate the state of uneven distribution (Step S605), and the unsealing operation is performed again (Step S606). For the new developing device in which the uneven distribution is not detected, the unsealing operation is completed in Step S607, and the processing is ended.

As described above, also in the second embodiment, the uneven distribution of the initial developer in the developing device is detected at the time of performing the unsealing operation with respect to the new developing device, and the unsealing operation is performed after the uneven distribution of the developer is eliminated, thereby being capable of completing the unsealing operation without causing excessively large load on the drive train.

### Modification Example

The exemplary embodiments of the present invention are described above, but the present invention is not limited to those embodiments and can be modified and changed variously within the scope of the gist thereof.

### Modification Example 1

In the above-mentioned embodiments, based on the output of the determination portion which is configured to determine the presence of the uneven distribution of the developer, the conveyance screw A 400 being the conveyance member is reversely rotated, in the case where the uneven distribution is present, before or at the time of peeling the sealing member from the opening. However, the present invention is not limited to this configuration. The determination portion which is configured to determine the presence of the uneven distribution of the developer may be omitted, and the conveyance screw A 400 being the conveyance member may be rotated in the second direction reverse to the first direction before being rotated in the first direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-163446, filed Aug. 24, 2016, which is hereby incorporated by reference herein in its entirety.

What is claimed is:

1. An image forming apparatus, comprising:
a developer carrying member configured to carry developer;
a first chamber configured to store the developer and to convey the developer;
a second chamber communicating to the first chamber to circulate the developer;
a first opening portion through which the developer is received from the first chamber to the second chamber;
a second opening portion through which the developer is received from the second chamber to the first chamber;
a conveyance member arranged in the first chamber and configured to rotate in a first direction to convey the developer to the first opening portion;
a sealing member configured to seal the first opening portion and the second opening portion so as to store the developer in the first chamber;
a rotatable rotary member configured to peel the sealing member from the first opening portion through reception of a drive force;
a determination portion configured to determine presence of uneven distribution in the first chamber under a state in which the sealing member seals the first opening portion; and
a controller configured to control rotation of the rotary member based on output of the determination portion so as to rotate the conveyance member in a second direction reverse to the first direction before peeling the sealing member from the first opening portion or in a course of an operation of peeling the sealing member from the first opening portion when the uneven distribution, in which a large amount of developer is present on a side of the first opening portion, is present in the first chamber.

2. An image forming apparatus according to claim 1, further comprising:
a driving portion configured to drive the rotary member and the conveyance member; and
a one-way transmission portion, which is connected between the driving portion and the rotary member, and through which a drive force is transmitted when rotating the conveyance member in the first direction and the drive force is prevented to be transmitted when rotating the conveyance member in the second direction.

3. An image forming apparatus according to claim 1, wherein the determination portion comprises a sensor configured to detect an amount of the developer in the first chamber as a change in inductance, compares an output value of the sensor with a predetermined value set in advance, and determines the presence of the uneven distribution of the developer based on a result of comparison.

4. An image forming apparatus according to claim 2, wherein the determination portion comprises a current detector configured to detect a drive current of the driving portion, compares an output value of the current detector with a predetermined value set in advance, and determines the presence of the uneven distribution of the developer based on a result of comparison.

5. An image forming apparatus according to claim 3, wherein the sensor is arranged at a position closer to the first opening portion than to the second opening portion.

6. An image forming apparatus according to claim 1, wherein, when the conveyance member is rotating in the second direction, the controller switches, at least before termination of the operation of peeling the sealing member from the first opening portion, to an operation in which the conveyance member is rotated in the first direction.

7. An image forming apparatus according to claim 1, wherein, when the conveyance member is rotating in the second direction, the controller switches rotation from the rotation in the second direction to the rotation in the first direction based on output of the determination portion.

8. An image forming apparatus, comprising:
a developer carrying member configured to carry developer;
a first chamber configured to store the developer and to convey the developer;
a second chamber communicating to the first chamber to circulate the developer;
a first opening portion through which the developer is received from the first chamber to the second chamber;
a second opening portion through which the developer is received from the second chamber to the first chamber;
a conveyance member arranged in the first chamber and configured to rotate in a first direction to convey the developer to the first opening portion;
a sealing member configured to seal the first opening portion and the second opening portion so as to store the developer in the first chamber;
a rotary member configured to peel the sealing member from the first opening portion through reception of a drive force; and
a controller configured to control rotation of the rotary member so as to have a time period in which the conveyance member is rotated in a second direction reverse to the first direction before peeling the sealing member from the first opening portion or in a course of an operation of peeling the sealing member from the first opening portion.
